(19) United States
(12) Patent Application Publication
(10) Pub. No.: US 2012/0124669 A1
(43) Pub. Date: May 17, 2012

(54) Hindering Side-Channel Attacks in Integrated Circuits

(75) Inventors: Gary D. Carpenter, Austin, TX (US); Eren Kursun, Ossining, NY (US); Phillip J. Restle, Katonah, NY (US); Michael R. Scheuermann, Katonah, NY (US)

(73) Assignee: International Business Machines Corporation, Armonk, NY (US)

(21) Appl. No.: 12/945,155

(22) Filed: Nov. 12, 2010

(51) Int. Cl. G06F 21/00

(52) U.S. Cl. 726/25; 726/26

(57) ABSTRACT

A mechanism is provided for protecting a layer of functional units from side-channel attacks. A determination is made as to whether one or more subsets of functional units in a set of functional units in the layer of functional units is performing operations of a critical nature. Responsive to a determination that there is one or more subsets of functional units that are performing the operations of the critical nature, at least one concealing pattern is generated in a concealing layer in order to conceal the operations of the critical nature being performed by each of the subset of functional units. The concealing layer is electrically and physically coupled to the layer of functional units.

### BACKGROUND

The present application relates generally to an improved data processing apparatus and method and more specifically to mechanisms for hindering side-channel attacks in integrated circuits of cryptographic systems.

A cryptographic system (or a cipher system) is a method of hiding data so that only certain people can view it. Cryptography is the practice of creating and using cryptographic systems and cryptanalysis is the science of analyzing and reverse engineering cryptographic systems. In a cryptographic system, original data is called plaintext and protected data is called ciphertext. Encryption is a procedure used to convert plaintext into ciphertext and decryption is a procedure used to convert ciphertext into plaintext.

Side-channel attacks, also referred to as side-channel analysis, is a type of attack on a cryptographic system that utilizes the information unintentionally leaked from the real-world implementations of the cryptographic hardware via side-channels. These unintended side channels can include the instantaneous power consumption of the hardware, radiated electromagnetic fields or timing information leading to what are aptly named power analysis, electromagnetic analysis, and timing analysis, respectively. Sometimes secrets such as plaintext can be discovered directly, but often the goal of the attacker is to determine the secret keys used to protect the data. In one of the simplest cases, Simple Power Analysis (SPA), the bits of an important key might be seen directly in the power consumption of an integrated circuit using that key to perform an encryption or decryption operation.

Differential Power Analysis (DPA) uses statistical methods upon multiple power measurements, such as when different blocks of ciphertext are decrypted using the same key. Each decryption operation leaks a small amount of information via the power consumption of the device. It may be impossible to reconstruct a key from a single observation, but with power consumption measurements from many blocks of ciphertext all being decrypted with the same key, an attacker can learn the key.

Differential Electromagnetic Analysis DEMA uses statistical methods on electromagnetic measurements. Instead of monitoring the power consumption as is performed in the aforementioned Differential Power Analysis (DPA), DEMA monitors electromagnetic emanations from the cryptographic devices, and then the same statistical analysis as that for DPA is performed on the collected electromagnetic data to extract secret parameters. Thermal imaging is also frequently used to acquire key information. Using infrared cameras, the activity levels in different parts of the chip can be tracked and used.

Side-channel attacks can be effective on many different types of hardware implementations, such as the custom logic in application-specific integrated circuits (ASICs), the configurable logic in field programmable gate arrays (FPGAs), the hardware of a standard central processing unit (CPU) chip executing cryptographic software or firmware, or memory chips because most hardware leaks some information. Side-channel attacks are a threat whenever cryptographic calculations are performed by systems in which the attacker might have access to make the side-channel measurements. However, it should be noted that side-channel analysis can only be performed during the time the hardware device is actually performing operations.

### SUMMARY

In one illustrative embodiment, a method, in a data processing system, is provided for protecting a layer of functional units from side-channel attacks. The illustrative embodiment determines whether one or more subsets of functional units in a set of functional units in the layer of functional units is performing operations of a critical nature. The illustrative embodiment generates, in a concealing layer, at least one concealing pattern in order to conceal the operations of the critical nature being performed by each of the subset of functional units in response to determining that there is one or more subsets of functional units that are performing the operations of the critical nature. In the illustrative embodiment, the concealing layer is electrically and physically coupled to the layer of functional units.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a integrated circuit chip is provided. The integrated circuit chip may comprise one or more functional units, a concealing layer and a controller coupled to the one or more functional units and the concealing layer. The controller may comprise instructions which, when executed, cause the controller to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts an example diagram of a data processing environment in which illustrative embodiments of the present invention may be implemented;

FIG. 2 depicts an exemplary illustration of the implementation of a concealing layer in a data processing system in accordance with an illustrative embodiment;

FIG. 3 depicts an exemplary concealing layer in accordance with an illustrative embodiment;

FIG. 4 depicts an example of a set of concealing patterns in accordance with an illustrative embodiment;

FIG. 5 depicts an enlarged example of noise/heat generator in accordance with an illustrative embodiment;

FIGS. 6A and 6B depict examples of region specific concealing pattern implementation in accordance with an illustrative embodiment; and

FIG. 7 provides a flowchart outlining example operations performed by a controller and concealing layer in order to protect from side-channel attacks in accordance with an illustrative embodiment.

### DETAILED DESCRIPTION

The illustrative embodiments provide a concealing layer in a three-dimensional (3D) architecture or in a baseline two-dimensional (2D) chip to prevent an observer from obtaining a physical reading of a computing device by using the concealing layer(s) to conceal information on the computing device that are intended to be secret thus protecting the computing device from side-channel attacks. The concealing layer may typically be on the top of a single layer or a plurality of layers of a to-be-protected 3D stack and may be on the bottom of the 3D stack. Because the concealing layers are doing active work, the concealing layers create their own heat or noise that prevents an observer from obtaining any usable information about the operation of the components of the computing device that are intended to be secret. In addition, as the concealing layers are part of the active computing device, the concealing layers cannot be removed by an observer who wants to do imaging or other techniques to learn about the operation of the computing device without destroying the computing device.

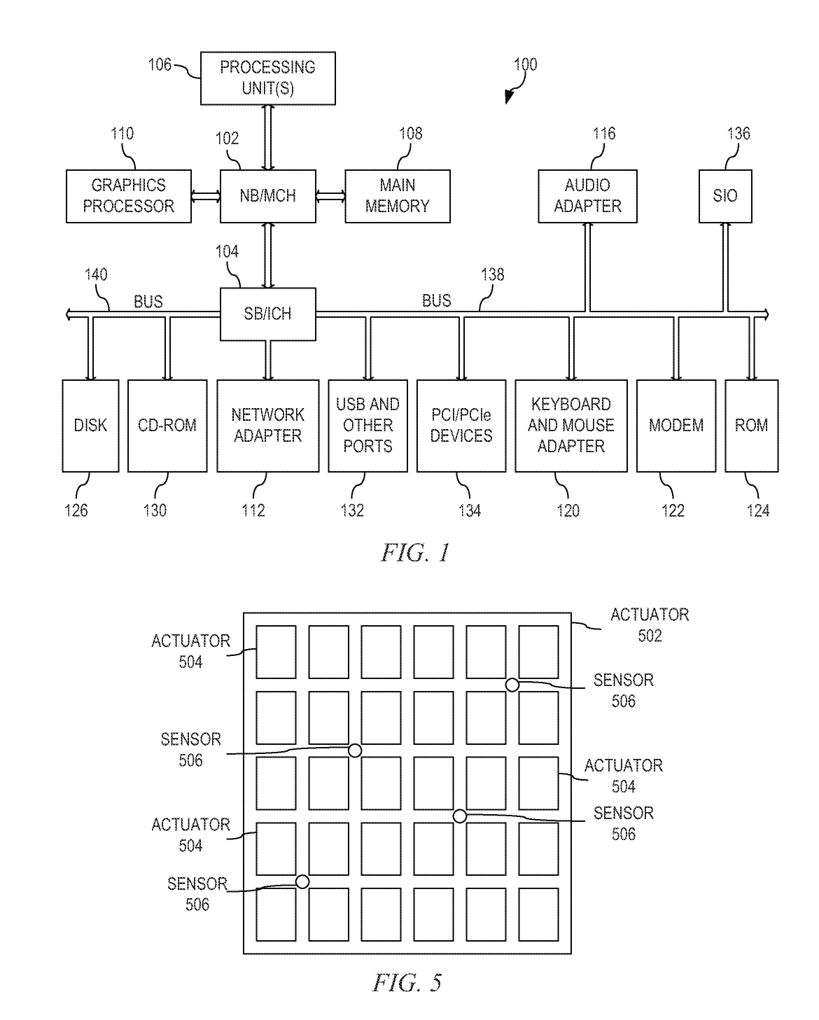

Thus, the illustrative embodiments may be utilized in many different types of data processing environments. In order to provide a context for the description of the specific elements and functionality of the illustrative embodiments, FIG. 1 is provided hereafter as an example environment in which aspects of the illustrative embodiments may be implemented. While the description following FIG. 1 will focus primarily on a single data processing device implementation of a 3D architecture that uses a concealing layer to prevent an observer from obtaining a physical reading of a computing device by concealing the parts of a computing device that are intended to be secret, this is only an example and is not intended to state or imply any limitation with regard to the features of the present invention.

With reference now to the figures and in particular with reference to FIG. 1, an example diagram of a data processing environment is provided in which illustrative embodiments of the present invention may be implemented. It should be appreciated that FIG. 1 is only an example and is not intended to assert or imply any limitation with regard to the environments in which aspects or embodiments of the present invention may be implemented. Many modifications to the depicted environments may be made without departing from the spirit and scope of the present invention.

With reference now to FIG. 1, a block diagram of an example data processing system is shown in which aspects of the illustrative embodiments may be implemented. Data processing system 100 is an example of a computer in which computer usable code or instructions implementing the processes for illustrative embodiments of the present invention may be located.

In the depicted example, data processing system 100 employs a hub architecture including north bridge and memory controller hub (NB/MCH) 102 and south bridge and input/output (I/O) controller hub (SB/ICH) 104. Processing unit 106, main memory 108, and graphics processor 110 are connected to NB/MCH 102. Graphics processor 110 may be connected to NB/MCH 102 through an accelerated graphics port (AGP).

In the depicted example, local area network (LAN) adapter 112 connects to SB/ICH 104. Audio adapter 116, keyboard and mouse adapter 120, modem 122, read only memory (ROM) 124, hard disk drive (HDD) 126, CD-ROM drive 130, universal serial bus (USB) ports and other communication ports 132, and PCI/PCIe devices 134 connect to SB/ICH 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash basic input/output system (BIOS).

HDD 126 and CD-ROM drive 130 connect to SB/ICH 104 through bus 140. HDD 126 and CD-ROM drive 130 may use, for example, an integrated drive electronics (IDE) or serial advanced technology attachment (SATA) interface. Super I/O (SIO) device 136 may be connected to SB/ICH 104.

An operating system runs on processing unit 106. The operating system coordinates and provides control of various components within the data processing system 100 in FIG. 1. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 100 (Java is a trademark of Sun Microsystems, Inc. in the United States, other countries, or both).

As a server, data processing system 100 may be, for example, an IBM® eServer™ System p® computer system, running the Advanced Interactive Executive) (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 100 may be a symmetric multiprocessor (SMP) system including a plurality of processors in processing unit 106. Alternatively, a single processor system may be employed.

Instructions for the operating system, the object-oriented programming system, and applications or programs are located on storage devices, such as HDD 126, and may be loaded into main memory 108 for execution by processing unit 106. The processes for illustrative embodiments of the present invention may be performed by processing unit 106 using computer usable program code, which may be located in a memory such as, for example, main memory 108, ROM 124, or in one or more peripheral devices 126 and 130, for example.

A bus system, such as bus 138 or bus 140 as shown in FIG. 1, may be comprised of one or more buses. Of course, the bus system may be implemented using any type of communication fabric or architecture that provides for a transfer of data between different components or devices attached to the fabric or architecture. A communication unit, such as modem 122 or network adapter 112 of FIG. 1, may include one or more devices used to transmit and receive data. A memory may be, for example, main memory 108, ROM 124, or a cache such as found in NB/MCH 102 in FIG. 1.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system without departing from the spirit and scope of the present invention.

Moreover, the data processing system 100 may take the form of any of a number of different data processing systems including client computing devices, server computing devices, a tablet computer, laptop computer, telephone or other communication device, a personal digital assistant (PDA), or the like. In some illustrative examples, data processing system 100 may be a portable computing device which is configured with flash memory to provide non-volatile memory for storing operating system files and/or user-generated data, for example. Essentially, data processing system 100 may be any known or later developed data processing system without architectural limitation.

In order to protect against side channel attacks, the illustrative embodiments provide a concealing layer that provides advance protection against simple and differential power and electromagnetic analysis attacks as well as thermal imaging. The concealing layer incorporates controllable/configurable arrays of noise and heat generator structures along with a hierarchical controller infrastructure that enables fine-grain dynamic control of the underlying noise and heat generator arrays. The controller works synchronously with the functional unit layer, while tracking the detailed activity levels, patterns of activity, regions of activity and the corresponding criticality levels. After assessing the characteristics and criticality of the computation running on the functional unit layer, the controller then generates control signals for the noise/heat generators to reach desired levels of power/temperature and electromagnetic noise in the concealing layer. The controller also provides power saving states. Depending on the criticality levels, the controller may scale down the activity levels/power dissipation of the non-critical units on either or both the concealing layer and the functional unit layer to minimize the information revealed in a side channel attack.

The concealing layer may also incorporate mechanical components to passively shield the data, which may include etchings, partial metal plates on different parts of the layer, thick wiring layers, mesh structures, or the like. These mechanical components may be placed in the stack between the concealing layers and the main layer(s) to be protected. Also, in other embodiments, the mechanical components may be placed at the top/bottom of the entire stack.

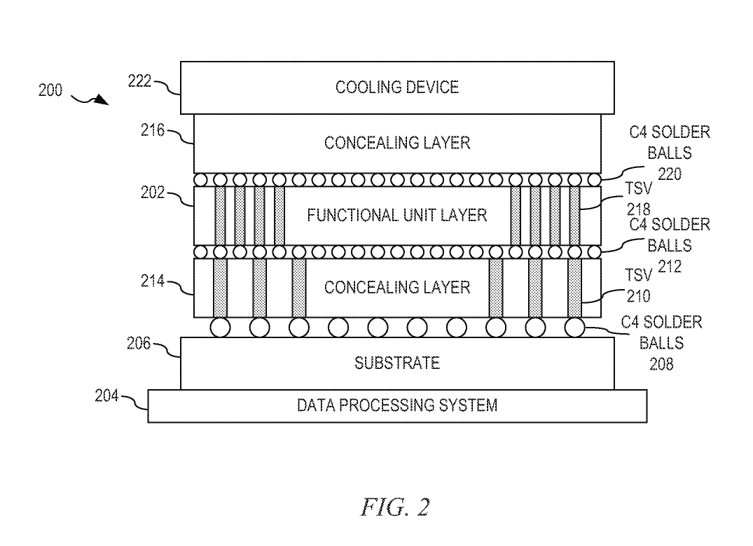

In the illustrative embodiments, one or more concealing layers may be provided in a data processing system, such as data processing system 100, in order to prevent an observer from obtaining a physical reading of a computing device by using the concealing layer(s) to conceal the parts of a computing device that are intended to be secret. FIG. 2 depicts an exemplary illustration of the implementation of a concealing layer in a data processing system in accordance with an illustrative embodiment. In FIG. 2, three-dimensional (3D) architecture 200 comprises functional unit layer 202 that may comprise a plurality of processor cores, register files, arrays, or other function units where cryptographic operations or operations of a critical nature may be performed, in accordance with an illustrative embodiment. Data processing system 204 may provide power (Vdd), ground, signaling, input/output (I/O), or the like, to functional unit layer 202 via substrate 206, a first plurality of C4 solder balls 208, through silicon via (TSVs) 210, and a second plurality of C4 solder balls 212 or inter-layer interconnect.

3D architecture 200 also comprises two concealing layers 214 and 216 that each comprise a configurable noise and heat generator infrastructure. Concealing layer 214 may receive power (Vdd), ground, signaling, input/output (I/O), or the like, from data processing system 204 via substrate 206, the first plurality of C4 solder balls 208, TSVs 210, and the second plurality of C4 solder balls 212. Concealing layer 216 may receive power (Vdd), ground, signaling, input/output (I/O), or the like, from data processing system 204 via substrate 206, the first plurality of C4 solder balls 208, TSVs 210, the second plurality of C4 solder balls 212, TSVs 218, and a third set of C4 solder balls 220. Heat may be removed from 3D architecture 200 by cooling device 222, which may be a cold plate, a heat sink, or the like, coupled to concealing layer 216.

Each of concealing layers 214 and 216 may either be synchronous or asynchronous with functional unit layer 202 and may invert or divert patterns that may be observable in side channel attacks. That is, each of concealing layers 214 and 216 may invert or divert any patterns generated by functional unit layer 202 by generating more complex patterns, which protect from most sophisticated side-channel attacks. Each of concealing layers 214 and 216 may receive information from functional unit layer 202 (the layer to be protected) and generate control signals that are implemented by one or more of a plurality of heat/noise generators in concealing layers 214 and 216. The information may be provided directly by the functional unit layer 202 through specialized hardware, an on-chip resource manager, system software, or the like, or may be observed by on-chip sensors and hardware counters. Depending on the task or chip criticality level in functional unit layer 202, concealing layers 214 and 216 may dynamically adjust and customize protection levels for different components in functional unit layer 202, by customizing patterns for different computation types, all the while minimizing any energy overhead. While 3D architecture 200 is shown to comprise concealing layer 214 and 216, other illustrative embodiments may only comprise one concealing layer, either above or below functional unit layer 202 without departing from the spirit and scope of the invention.

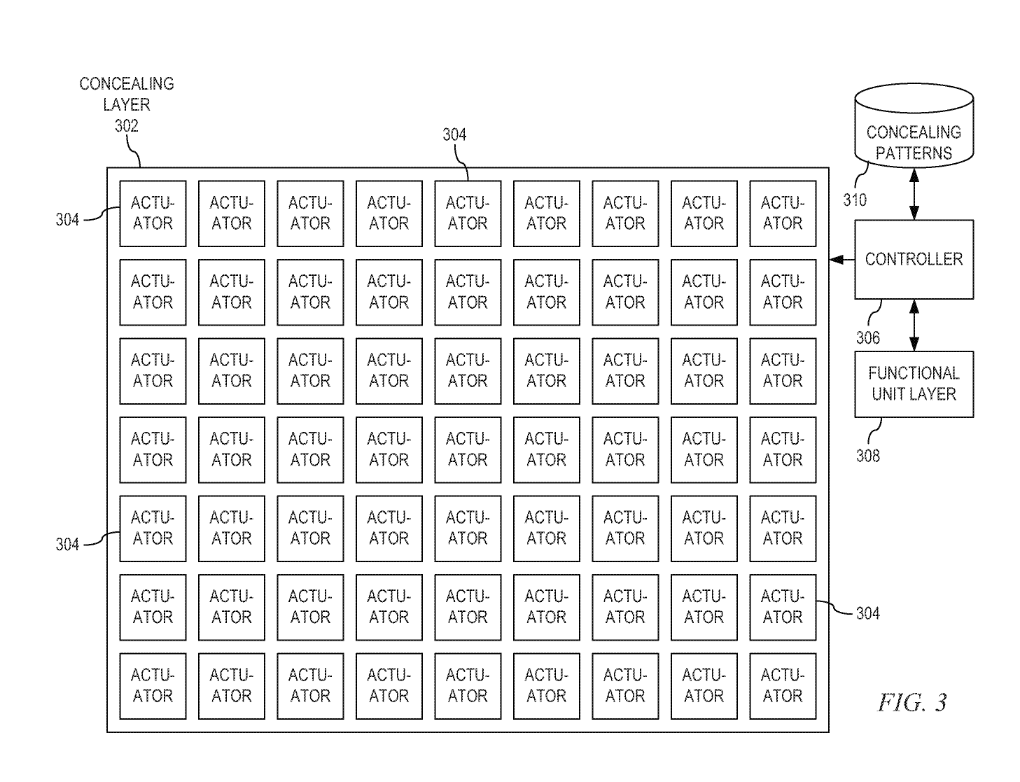

FIG. 3 depicts an exemplary concealing layer, such as concealing layers 214 and 216 of FIG. 2, in accordance with an illustrative embodiment. Concealing layer 302 comprises a plurality of actuators 304 including noise/heat generators, arrays, register files, or the like that are each individually controlled by controller 306. In addition to actuators 304, concealing layer 302 may also comprise embedded macros such as functional units, arrays, register files, or the like, that may be activated by controller 306 on an as needed basis. While controller 306 is shown to be external to concealing layer 302, controller 306 may be either external or internal to concealing layer 302, but is illustrated external in order to clearly indicate the operation of concealing layer 302. In operation, controller 306 is either pre-initialized or determines the layout of functional unit layer 308. That is, each functional unit, which may be either a processor core, register file, array, or other functional unit in functional unit layer 308, is generally configured to perform certain cryptographic operations or any task to be protected from side channel attacks. Further, any operation or task that requires one or more functional units in the plurality of functional units form a region within functional unit layer 308. Thus, functional unit layer 308 comprises a plurality of regions, each of which comprise one or more functional units.

Controller 306 is either pre-initialized or determines the regions (i.e., the layout) of functional unit layer 308. Controller 306 may determine the regions of functional unit layer 308 by interrogating each functional unit in the plurality of functional units in functional unit layer 308 for the specific task that functional unit is performing. Based on the identified tasks, controller 306 may group the one or more functional units into one or more regions. If a functional unit is configured to perform two or more tasks, then controller 306 may keep a record of the tasks and perform periodic updates with the functional unit as to which task is currently being performed by the functional unit. Alternatively, controller 306 may choose to determine a criticality and activity associated with each of the tasks performed by the functional unit and assign the functional unit to a region associated with the most critical of the tasks that are performed by the functional unit. Controller 306 may perform the criticality and activity assessment in combination with a system software stack, such as a hypervisor, virtual machine monitor, trusted operating system code, or the like, in the associated data processing system in combination with each of the individual components performing the cryptographic operation in functional unit layer 308. In cases where criticality information is not available at the beginning of the run, controller 306 may perform the assessment at run-time (through observing active blocks and hardware counters). In other cases, controller 306 may obtain the information based on a flag or interrupt from the functional unit.

Once controller 306 determines the criticality layout, controller 306 then associates regions of noise/heat generators in concealing layer 302 to match the layout of regions in functional unit layer 308. That is, for each region of one or more functional units in functional unit layer 308, controller 306 forms an associated region of actuators 304 in concealing layer 302. The associated regions may also be occupied by embedded macros such as functional units, arrays, register files, or the like, controller 306 may activate those embedded macros at a same time as actuators 304 within the region are activated. Controller 306 then proceeds to work either synchronously or asynchronously with functional unit layer 308 in order to track criticality of operations, which may be indicated by detailed activity levels, patterns of activity, regions of activity, and corresponding criticality levels, on a region-by-region basis of functional unit layer 308. The operations may comprise encryption operation, decryption operations, vector operations, or the like. In order to track the detailed activity levels, patterns of activity, regions of activity, and corresponding criticality levels of the operations, controller 306 may read hardware counters, sensor data, or the like, associated with each of the functional units in each region in functional unit layer 308.

After assessing the characteristics and criticality of the operations running on each of the functional units in a specific region, controller 306 may determine whether the activity in functional unit layer 308 exceeds a predetermined criticality and activity threshold, the predetermined criticality and activity threshold indicating that the tasks being performed in one or more of the regions of functional unit layer 308 being highly critical and may be provided by a system software stack, such as a hypervisor, virtual machine monitor, trusted OS code, or the like or with hardware or compiler flags. If the predetermined criticality and activity threshold is not exceeded, then controller 306 may access concealing patterns 310 to identify one or more patterns associated with an activity type and/or activity level of the tasks currently being performed in functional unit layer 308. Concealing patterns 310 may be in the form of a library, array, data structure, or the like, and is associated with controller 306. Each pattern in concealing patterns 310 has an associated current profile, temperature profile, electromagnetic profile, and power overhead. For example, a current profile may be a matrix of electrical current values per C4 or microC4 as is illustrated in the following matrix:

| | | | | |
|---|---|---|---|---|
| C11: 2 mA | C12: 2 mA | C13: 3 mA | . . . | C1N: 1 mA |
| C21: 1 mA | C22: 1 mA | C23: 1 mA | . . . | C2N: 1 mA |
| CM1: 2 mA | CM2: 2 mA | CM3: 1 mA | . . . | CMN: 1 mA |

The exemplary current profile may vary and be extended depending on what information in functional unit layer 308 needs to be protected. Similar profiles for temperature, EM, power overhead or the like, may also be utilized by controller 306. Controller 306 may pick a pattern that match the standards of the tasks currently being performed in functional unit layer 308 with a minimum power overhead.

Controller 306 may then generate control signals to specific ones of actuators 304 including noise/heat generators, arrays, register files, or the like, associated with the functional units in order for the selected pattern to be generated by those ones of actuators 304 to reach desired levels of power, temperature, and/or electromagnetic noise in concealing layer 302 to mask the operations being performed by the functional unit(s) in that region in functional unit layer 308. Controller 306 may also adjust power levels of functional unit layer 308 to compensate for any power overhead, if necessary. By controller 306 adjusting power levels within functional unit layer 308, controller 306 may improve the energy efficiency of the concealing operations being performed in concealing layer 302, by reducing uncritical computations in functional unit layer 308 to create a power budget for the highly critical concealing task. Such functionality may be highly important if the system is already running close to the power limits, where any additional concealing operations are power limited. Controller 306 then proceeds to reread hardware counters, sensor data, or the like, associated with each of the functional units in each region in functional unit layer 308 in order to track any changes in the criticality of operations in functional unit layer 308.

If the predetermined criticality and activity threshold is exceeded, then controller 306 may access concealing patterns 310 to determine a pattern to conceal activity on a region-by-region basis. In this instance, for each region, controller 306 may identify one or more patterns based on activity type and/or activity level as well as criticality and/or region. Further, controller may identify a specific pattern to use based on energy optimization, power concealment, electromagnetic concealment, thermal imaging, or the like, which may be identified in each pattern. In those regions that are performing less critical operation or no operations, controller 306 may also identify a global pattern to stitch regional patterns with minimum overhead in order to conceal total chip/layer power information of functional unit layer 308. These global patterns may also be referred to as faux patterns. Faux patterns can also be regional to create the impression of concealing critical computation underneath to distract the observer. Controller 306 may then generate control signals to specific ones of actuators 304 associated with the functional units in order for the selected patterns to be generated by those ones of actuators 304 to reach desired levels of power, temperature, and/or electromagnetic noise in concealing layer 302 to mask the operations being performed by the functional unit(s) in that region in functional unit layer 308. Additionally, controller 306 may monitor the noise and heat generated by each of actuators 304 using one or more sensors within each of actuators 304 in order to determine that the pattern being generated by each of actuators 304 is an adequate pattern to conceal the activity being performed in an associated region within functional unit layer 308. If controller 306 determines that the selected pattern is not sufficient to adequately conceal the activity being performed in the associated region within functional unit layer 308, controller 306 may select and implement a different pattern. That is, controller 306 works in stages, after controller 306 selects the first pass pattern, controller 306 observes the outcome of the use of the selected pattern using sensors. If the outcome of the selected pattern does not provide the desired effect, then controller 306 may select a more aggressive pattern or more energy efficient pattern depending on the measured data. Controller 306 may also adjust power levels of functional unit layer 308 to compensate for any power overhead, if necessary. Controller 306 then proceeds to reread hardware counters, sensor data, or the like, associated with each of the functional unit in each region in functional unit layer 308 in order to track any changes in the criticality of operations in functional unit layer 308.

Each of the control signals generated by controller 306 are based on the criticality and activity type of the computations or operations being performed by one or more functional units in a specific region of functional unit layer 308. That is, each of actuators 304 are individually and dynamically controllable by controller 306, such that one noise/heat generator may produce one pattern while an adjacent noise/heat generator may produce another pattern. In order to determine which pattern a specific subset of actuators 304 should produce, controller 306 first identifies the activity type and activity level for each region of functional units. For each region, controller 306 identifies one or more patterns associated with activity type, activity level, criticality, and/or region, in concealing patterns 310, which may be in the form of a library, array, data structure, or the like, that is associated with controller 306. Each pattern in concealing patterns 310 has an associated current profile, temperature profile, electromagnetic profile, and power overhead. While the illustrative embodiments depict only controller 306, in another embodiment there may be a plurality of controllers on the chip and each region manages itself in an ad-hoc fashion. In addition, there may be a global controller responsible for coordinating the plurality of controllers.

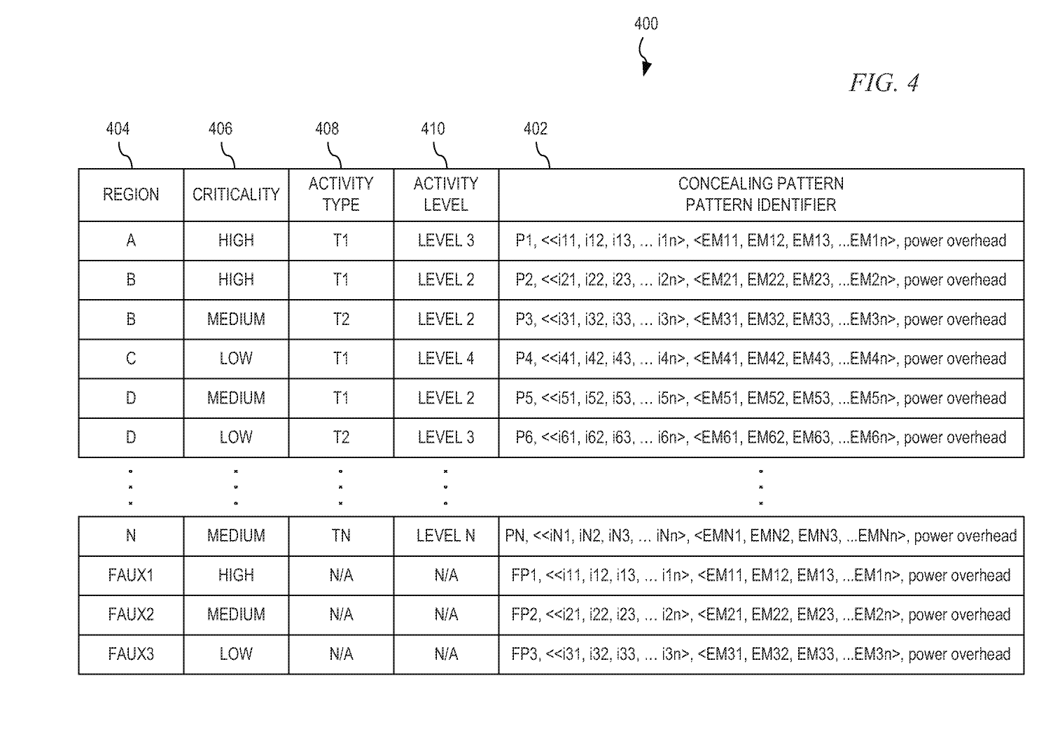

FIG. 4 depicts an example of a set of concealing patterns, such as those in concealing patterns 310 of FIG. 3, that may be stored in a library, array, data structure or the like, in accordance with an illustrative embodiment. Concealing pattern table 400 depicts a plurality of patterns that may be used by a controller. Each of the concealing patterns 402 are identifiable based on identifiers, such as region 404, criticality 406, activity type 408, and activity level 410. The controller of the concealing layer may use any or all of the identifiers to select one or more of concealing patterns 402 to be implemented by one or more of the noise/heat generators in the concealing layer. For example, if the predetermined criticality and activity threshold is not exceeded, then the controller may identify one or more of patterns 402 using only activity type 408 and/or activity level 410. As another example, if the predetermined criticality and activity threshold is exceeded, then the controller may identify one or more of concealing patterns 402 using region 404, criticality 406, activity type 408, and/or activity level 410. While concealing pattern table 400 only uses region 404, criticality 406, activity type 408, and activity level 410 to identify concealing patterns 402, the illustrative embodiments recognize that any type of identifier may be used by the controller to identify concealing patterns without departing from the spirit and scope of the invention.

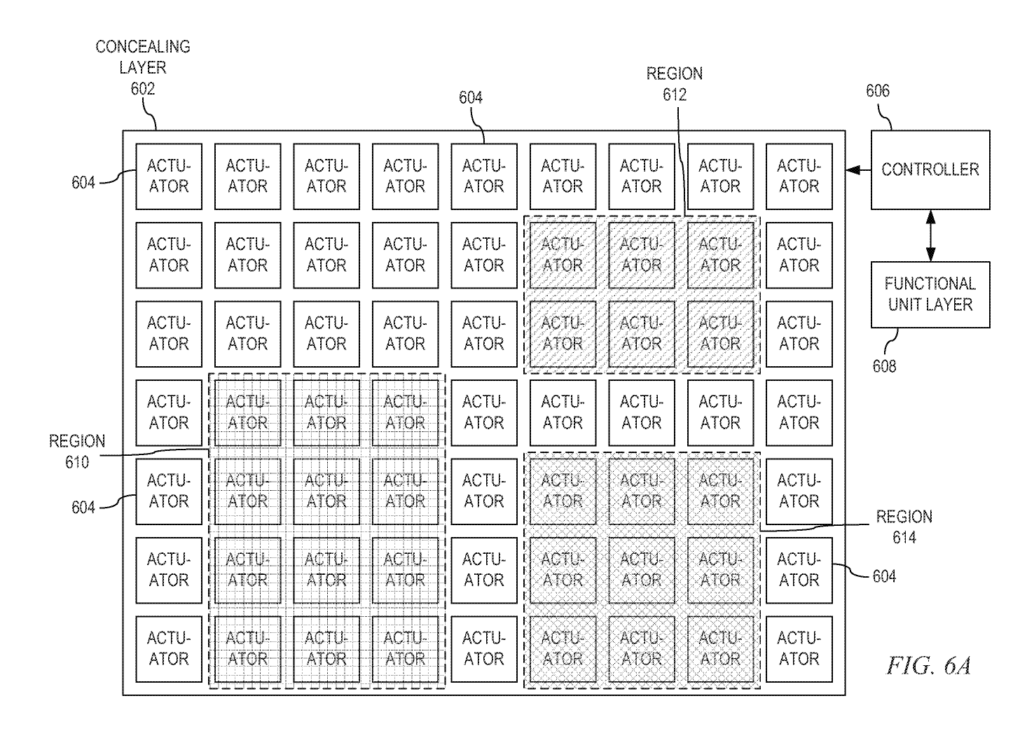

FIG. 5 depicts an enlarged example of actuator, such as actuator 304 of FIG. 3, in accordance with an illustrative embodiment. Each actuator 502 may comprise a plurality of actuators 504, that may be either a noise actuator, a heat actuator, a electromagnetic actuator, or the like that may generate a selected pattern that conceals the activity within an associated functional unit layer in order to protect from side-channel attacks. In addition to the plurality of actuators 504, actuator 502 may also comprise a plurality of sensors 506 that may provide feedback with regard to temperature, electromagnetic fields, current, noise, or the like, in order to determine that the pattern being generated by the plurality of actuators 504 is an adequate pattern to conceal the activity being performed in an associated region within the functional unit layer.

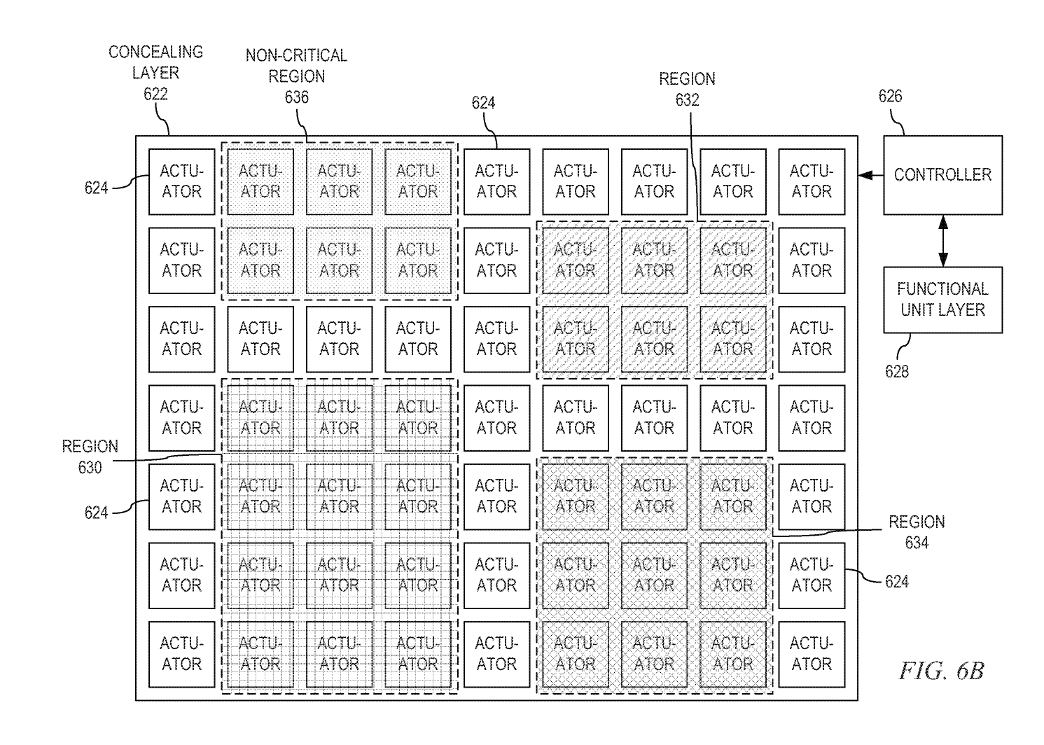

FIGS. 6A and 6B depict examples of region specific concealing pattern implementation in accordance with an illustrative embodiment. In FIG. 6A, controller 606 has determined, based on the operation being performed in functional unit layer 608, that three different regions 610, 612, and 614 within concealing layer 602 require three different concealing patterns. In region 610, controller 606 sends control signals to the required ones of actuators 604 associated with region 610 to each generate concealing pattern Pᵢⱼ. In region 612, controller 606 sends control signals to the required ones of actuators 604 associated with region 612 to each generate concealing pattern Pₙₘ. In region 614, controller 606 sends control signals to the required ones of actuators 604 associated with region 614 to each generate concealing pattern P_{xy}. Again, concealing patterns Pᵢⱼ, Pₙₘ, and P_{xy} are all different concealing patterns that are region specific.

In FIG. 6B, controller 626 has determined, based on the operation being performed in functional unit layer 628, that three different regions 630, 632, and 634 within concealing layer 622 require three different concealing patterns. Additionally, controller 626 has determined that an additional non-critical region 636 requires a faux pattern be generated in order to distract any side attack, such that an observer of the side attack may tend to believe that something critical is occurring in the non-critical region 636. In region 630, controller 626 sends control signals to the required ones of noise/heat generators 624 associated with region 630 to each generate concealing pattern Pᵢⱼ. In region 632, controller 626 sends control signals to the required ones of noise/heat generators 624 associated with region 632 to each generate concealing pattern Pₙₘ. In region 634, controller 626 sends control signals to the required ones of noise/heat generators 624 associated with region 634 to each generate concealing pattern P_{xy}. Additionally, in region 636, controller 626 sends control signals to the required ones of noise/heat generators 624 associated with region 634 to each generate faux concealing pattern Pᵣₛ. Once again, concealing patterns Pᵢⱼ, Pₙₘ, P_{xy}, and Pᵣₛ are all different concealing patterns that are region specific.

Thus, the illustrative embodiments provide a concealing layer that provides advance protection against simple and differential power and electromagnetic analysis attacks as well as thermal imaging. The concealing layer incorporates controllable/configurable arrays of noise and heat generator structures along with a hierarchical controller infrastructure that enables fine-grain dynamic control of the underlying noise and heat generator arrays. The controller works synchronously with the functional unit layer, while tracking the detailed activity levels, patterns of activity, regions of activity and the corresponding criticality levels. After assessing the characteristics and criticality of the computation running on the functional unit layer, the controller then generates control signals for the noise/heat generators to reach desired levels of power/temperature and electromagnetic noise in the concealing layer. The controller also provides power saving states. Depending on the criticality levels, the controller may scale down the computation/power dissipation of the non-critical units on either or both the concealing layer and the functional unit layer to minimize the energy consumption related to the concealing act and balances the trade off between the information revealed in a side channel attack and energy overhead.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

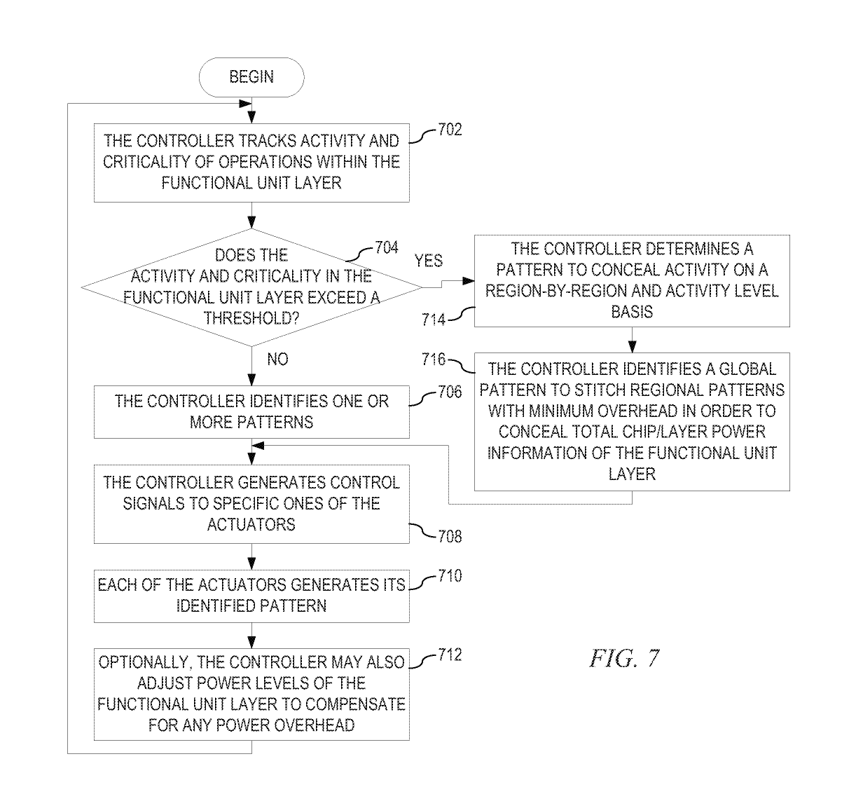

Referring now to FIG. 7, this figure provides a flowchart outlining example operations performed by a controller and concealing layer in order to protect from side-channel attacks in accordance with an illustrative embodiment. As the operation begins, a controller works either synchronously or asynchronously with the functional unit layer in order to track a criticality and activity of operations, which may be indicated by detailed activity levels, patterns of activity, regions of activity, and corresponding criticality levels, or a region-by-region basis of the functional unit layer (step 702). The controller constantly tracks the activity and criticality levels throughout the entire operation. The patterns and criticality levels may change during run-time and the controller and/or actuators adjust to such run-time changes by constantly monitoring, reassessing, readjusting, or the like, to the changes. The controller may perform the criticality and activity assessment in combination with a system software stack, such as a hypervisor, virtual machine monitor, trusted operating system code, or the like, in the associated data processing system in combination with each of the individual components performing the cryptographic operation in the functional unit layer. In order to track the detailed activity levels, patterns of activity, regions of activity, and corresponding criticality levels, the controller may read hardware counters, sensor data, or the like, associated with each of the functional units in each region in the functional unit layer.

After assessing the characteristics and criticality of the operations running on each of the functional units in a specific region, the controller determines whether the criticality and activity in the functional unit layer exceeds a predetermined criticality and activity levels (as may be quantified with thresholds and similar criteria) (step 704). The predetermined criticality and activity threshold indicates that the tasks being performed in one or more of the regions of the functional unit layer being highly critical. If at step 704 the predetermined criticality and activity threshold is not exceeded, then the controller accesses a set of concealing patterns to identify one or more patterns associated with an activity type and/or activity level of the tasks currently being performed in the functional unit layer (step 706). Once one or more concealing patterns have been identified, the controller generates control signals to specific ones of the actuators associated with the functional units (step 708). Each of the actuators generates its identified pattern to reach desired levels of power, temperature, and/or electromagnetic noise in order to mask the operations being performed by the functional unit(s) in that region in functional unit layer with which the actuator is associated (step 710). Optionally, the controller may also adjust power levels of the functional unit layer to compensate for any power overhead (step 712) with the operation returning to step 702 thereafter. That is, the controller then proceeds to reread hardware counters, sensor data, or the like, associated with each of the functional units in each region in the functional unit layer in order to track any changes in the criticality of operations in the functional unit layer.

If at step 704 the predetermined critical activity threshold is exceeded, then the controller may access the concealing patterns to determine a pattern to conceal activity on a region-by-region basis (step 714). In this instance, for each region, the controller may identify one or more patterns based on activity type and/or activity level as well as criticality and/or region. In those regions that are performing less critical operations or no operations, the controller also identifies a global pattern to stitch regional patterns with minimum overhead in order to conceal total chip/layer power information of the functional unit layer (step 716). Additionally, the controller may monitor the noise and heat generated by each of the actuators using one or more sensors within each of the noise/heat generators in order to determine that the pattern being generated by each of the noise/heat generators is an adequate pattern to conceal the activity being performed in an associated region within the functional unit layer. If the controller determines that the selected pattern is not sufficient to adequately conceal the activity being performed in the associated region within the functional unit layer, the controller may select and implement a different pattern. The operation then proceeds to step 708 thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for protecting against side channel attacks. That is, the illustrative embodiments provide a concealing layer that provides advance protection against simple and differential power and electromagnetic analysis attacks as well as thermal imaging. The concealing layer incorporates controllable/configurable arrays of noise and heat generator structures along with a hierarchical controller infrastructure that enables fine-grain dynamic control of the underlying noise and heat generator arrays. The controller works synchronously with the functional unit layer, while tracking the detailed activity levels, patterns of activity, regions of activity and the corresponding criticality levels. After assessing the characteristics and criticality of the computation running on the functional unit layer, the controller then generates control signals for the noise/heat generators to reach desired levels of power/temperature and electromagnetic noise in the concealing layer. The controller also provides power saving states. Depending on the criticality levels, the controller may scale down the computation/power dissipation of the non-critical units on either or both the concealing layer and the functional unit layer to minimize the information revealed in a side channel attack.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. An integrated circuit chip, comprising:
a layer of functional units;
a concealing layer, wherein the concealing layer is electrically and physically coupled to the layer of functional units;
and a controller coupled to the concealing layer and the layer of functional units, wherein the controller:
determines whether one or more subsets of functional units in a set of functional units in the layer of functional units is performing operations of a critical nature; and
responsive to determining that there is one or more subsets of functional units that are performing the operations of the critical nature, generate in the concealing layer at least one pattern in order to mask the operations of the critical nature being performed by each of the subset of functional units.

2. The integrated circuit chip of claim 1, wherein the determining whether the one or more subsets of functional units in the set of functional units in the layer of functional units is performing operations of a critical nature further comprises the controller:
tracking a criticality and an activity of the operations, wherein the activity and criticality are indicated by at least one of activity levels, patterns of activity, regions of activity, or corresponding criticality levels and wherein the criticality and activity assessment is performed by at least one of a controller, a hypervisor, a virtual machine monitor, or trusted operating system code.

3. The integrated circuit chip of claim 2, wherein the at least one of the activity levels, the patterns of activity, the regions of activity, or the corresponding criticality levels are tracked by reading at least one of hardware counters or sensor data associated with each functional unit in the set of functional units in the layer of functional units.

4. The integrated circuit chip of claim 1, wherein the controller determining whether the one or more subsets of functional units in a set of functional units in the layer of functional units is performing operations of a critical nature further comprises the controller:
determining whether a criticality and an activity in the functional unit layer exceeds a predetermined criticality and activity threshold.

5. The integrated circuit chip of claim 1, wherein the at least one concealing pattern is identified based on at least one of an activity type of the operations being performed by the one or more subsets of functional units or an activity level of the operations currently being performed by the one or more subsets of functional units.

6. The integrated circuit chip of claim 1, wherein the at least one concealing pattern is identified based on at least one of an activity type of the operations being performed by the one or more subsets of functional units, an activity level of the operations currently being performed by the one or more subsets of functional units, a criticality of the operations currently being performed by the one or more subsets of functional units, or a region where the operations are currently being performed by the one or more subsets of functional units.

7. The integrated circuit chip of claim 1, wherein the at least one concealing pattern is generated by at least one actuator and wherein the at least one actuator generates the at least one concealing pattern in response to a signal received from the controller that identifies the concealing pattern to be generated by the actuator.

8. The integrated circuit chip of claim 1, further comprising the controller:
monitoring the concealing pattern generated by the at least one noise/heat generator;
determining if the concealing pattern being generated by the at least one noise/heat generator adequately conceals the operations of the critical nature being performed by the one or more subsets of functional units;
responsive to the concealing pattern being generated failing to adequately conceal the operations of the critical nature being performed by the one or more subsets of functional units, determining at least one other concealing pattern that will conceal the operations of the critical nature being performed by the one or more subsets of functional units; and
generating in the concealing layer the at least one other concealing pattern in order to conceal the operations of the critical nature being performed by each of the subset of functional units.

9. The integrated circuit chip of claim 1, wherein the concealing pattern specifies at least one of a current profile, an electromagnetic profile, and a power overhead.

10. The integrated circuit chip of claim 1, further comprising:
a passive shielding element inserted between the concealing layer and the layer of functional units, wherein the passive shielding element is at least one of a etching, a metal plate, a set of thick wiring layers, or a mesh structure.

11. The integrated circuit chip of claim 1, wherein the controller is a plurality of controllers and wherein each controller in the plurality of controllers is associated with at least one actuator and wherein the at least one actuator generates the at least one concealing pattern in response to a signal received from the controller that identifies the concealing pattern to be generated by the actuator.

12. A method, in a data processing system, for protecting a layer of functional units from side-channel attacks, the method comprising:
determining whether one or more subsets of functional units in a set of functional units in the layer of functional units is performing operations of a critical nature; and
responsive to determining that there is one or more subsets of functional units that are performing the operations of the critical nature, generating in a concealing layer at least one concealing pattern in order to conceal the operations of the critical nature being performed by each of the subset of functional units, wherein the concealing layer is electrically and physically coupled to the layer of functional units.

13. The method of claim 12, wherein determining whether the one or more subsets of functional units in the set of functional units in the layer of functional units is performing operations of a critical nature further comprises:
tracking a criticality and an activity of the operations, wherein the activity and criticality are indicated by at least one of activity levels, patterns of activity, regions of activity, or corresponding criticality levels and wherein the criticality and activity assessment is performed by at least one of a controller, a hypervisor, a virtual machine monitor, or trusted operating system code.

14. The method of claim 13, wherein the at least one of the activity levels, the patterns of activity, the regions of activity, or the corresponding criticality levels are tracked by reading at least one of hardware counters or sensor data associated with each functional unit in the set of functional units in the layer of functional units.

15. The method of claim 12, wherein determining whether the one or more subsets of functional units in a set of functional units in the layer of functional units is performing operations of a critical nature further comprises:
determining whether a criticality and an activity in the functional unit layer exceeds a predetermined criticality and activity threshold.

16. The method of claim 12, wherein the at least one concealing pattern is identified based on at least one of an activity type of the operations being performed by the one or more subsets of functional units or an activity level of the operations currently being performed by the one or more subsets of functional units.

17. The method of claim 12, wherein the at least one concealing pattern is identified based on at least one of an activity type of the operations being performed by the one or more subsets of functional units, an activity level of the operations currently being performed by the one or more subsets of functional units, a criticality of the operations currently being performed by the one or more subsets of functional units, or a region where the operations are currently being performed by the one or more subsets of functional units.

18. The method of claim 12, wherein the at least one concealing pattern is generated by at least one noise/heat generator and wherein the at least one noise/heat generator generates the at least one concealing pattern in response to a signal received from a controller that identifies the concealing pattern to be generated by the noise/heat generator.

19. The method of claim 12, further comprising:
monitoring the concealing pattern generated by the at least one noise/heat generator;
determining if the concealing pattern being generated by the at least one noise/heat generator adequately conceals the operations of the critical nature being performed by the one or more subsets of functional units;
responsive to the concealing pattern being generated failing to adequately conceal the operations of the critical nature being performed by the one or more subsets of functional units, determining at least one other concealing pattern that will conceal the operations of the critical nature being performed by the one or more subsets of functional units; and
generating in the concealing layer the at least one other concealing pattern in order to conceal the operations of the critical nature being performed by each of the subset of functional units.

20. The method of claim 12, wherein the concealing pattern specifies at least one of a current profile, an electromagnetic profile, and a power overhead.

21. A computer program product comprising a computer readable storage medium having a computer readable program stored therein, wherein the computer readable program, when executed on a computing device, causes the computing device to:
determine whether one or more subsets of functional units in a set of functional units in the layer of functional units is performing operations of a critical nature; and
responsive to determining that there is one or more subsets of functional units that are performing the operations of the critical nature, generate in a concealing layer at least one concealing pattern in order to conceal the operations of the critical nature being performed by each of the subset of functional units, wherein the concealing layer is electrically and physically coupled to the layer of functional units.

22. The computer program product of claim 21, wherein the computer readable program to determine whether the one or more subsets of functional units in the set of functional units in the layer of functional units is performing operations of a critical nature further causes the computing device to:
track a criticality and an activity of the operations, wherein the activity and criticality are indicated by at least one of activity levels, patterns of activity, regions of activity, or corresponding criticality levels and wherein the criticality and activity assessment is performed by at least one of a controller, a hypervisor, a virtual machine monitor, or trusted operating system code, wherein the at least one of the activity levels, the patterns of activity, the regions of activity, or the corresponding criticality levels are tracked by reading at least one of hardware counters or sensor data associated with each functional unit in the set of functional units in the layer of functional units.

23. The computer program product of claim 21, wherein the computer readable program to determine whether one or more subsets of functional units in a set of functional units in the layer of functional units is performing operations of a critical nature further causes the computing device to:
determine whether a criticality and an activity in the functional unit layer exceeds a predetermined criticality and activity threshold.

24. The computer program product of claim 21, wherein the computer readable program further causes the computing device to:
monitor the concealing pattern generated by the at least one noise/heat generator;
determine if the concealing pattern being generated by the at least one noise/heat generator adequately conceals the operations of the critical nature being performed by the one or more subsets of functional units;
responsive to the concealing pattern being generated failing to adequately conceal the operations of the critical nature being performed by the one or more subsets of functional units, determine at least one other concealing pattern that will conceal the operations of the critical nature being performed by the one or more subsets of functional units; and
generate in the concealing layer the at least one other concealing pattern in order to conceal the operations of the critical nature being performed by each of the subset of functional units.
